(19) United States
(12) Patent Application Publication
(10) Pub. No.: US 2010/0146070 A1
(43) Pub. Date: Jun. 10, 2010

(54) FILTERING TRANSFERRED DATA

(75) Inventor: Ian McDowall, Cambridge (GB)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/520,539

(22) PCT Filed: Dec. 21, 2007
(86) PCT No.: PCT/GB2007/004959

§ 371 Date: Feb. 8, 2010

(30) Foreign Application Priority Data
Dec. 21, 2006 (GB) 0625641.6
Oct. 25, 2007 (GB) 0720996.8

(51) Int. Cl. G06F 15/167

(52) U.S. Cl. 709/216

(57) ABSTRACT

A data transfer client device comprising: memory for storing at least one dataset comprising a plurality of data fields and at least one filter definition comprising data defining which of the data fields can be accessed by a particular server; an interface for communicating with a data transfer server, whereby a data transfer server can access a dataset stored in the memory; and a data transfer controller for policing access during a data transfer operation by a data transfer server to the data fields, the data transfer controller being arranged to determine in dependence on the filter definition whether the data transfer server can access particular data fields and to deny the server access to those data fields to which the data transfer controller determines that the data transfer server cannot have access.

This invention relates to transferring data between a device and a data store. One example of such a situation is when data on a portable device such as a mobile phone is synchronised with data on a server or other storage device. The data that is transferred could represent any underlying information, including user-generated content and/or instructions.

Synchronisation involves replicating data from a dataset stored on one device to a dataset stored on another device. One use of this facility is to allow a user to back up data that is stored on a vulnerable device. Another reason for synchronising is to allow the dataset to be accessed from multiple devices. For example, a user may wish to access his email account or information about his contacts from both his desktop computer and his mobile phone. In order for the datasets that are stored locally on such client devices to be kept up-to-date, the data must be synchronised from time to time.

Various protocols are available for synchronising data between devices. Typically, one of the devices acts as a server and the other device as a client during the synchronisation transaction. The client informs the server of the data that has been changed in its dataset since the last synchronisation with the server. The server incorporates that data into its dataset as appropriate, and informs the client of changes that are to be made in the client's dataset. It may be that other devices hold datasets that are being synchronised from time to time with either the server or the client's dataset, and various rules can be implemented to reduce the chance that data becomes corrupted due to confusion over which dataset takes precedence.

In addition to mirroring a dataset over multiple devices, the user may want a single client device to store multiple datasets. For example, the user may want a client device to store one dataset that holds email data from a work email account of which the master copy is kept on a work email server; another dataset that holds email data from a personal email account of which the master copy is kept on a web server; and a third dataset that holds configuration data which defines the configuration of the device of which the master copy is kept on a device management server.

The Open Mobile Alliance (OMA) has defined various optional standards for data transfer. These include a data synchronisation (DS) standard and a device management (DM) standard. The DS standard defines a protocol that can be used for synchronising application data such as emails and contacts between devices. The DM standard defines a protocol that can be used by a server to request and set management data such as configuration settings and is typically used for allowing a mobile phone network operator to remotely configure user equipment such as mobile phones.

When a client device is to synchronise to a server using the OMA DS protocol the client device and the server first exchange data to authenticate themselves to each other. Once this has been done the server can have authority to synchronise its data with any user dataset on the client device. The dataset will typically consist of a number of records (e.g. contact records). Subject to exceptions for the purpose of avoiding synchronisation conflicts, each device then transmits to the other device all those records in its copy of the dataset that have been changed since the last synchronisation with the other device. If a record has been deleted on either device then that device informs the other device of that deletion.

The dataset will typically be organised such that each record has data in one or more fields (e.g. name, phone number, email address, photo, personal). Once the synchronisation process is initiated for a particular dataset the devices exchange a list of which fields in the dataset they each recognise. The data from a record that each device transmits during synchronisation is limited to the fields that the other device has indicated that it recognises. This allows the amount of data that is transferred between the devices during synchronisation to be reduced. In a similar way, data of a field may be selectively omitted during synchronisation even though both devices recognise the field. For instance in the case of an email dataset only the headers of emails could be downloaded to the client device.

It is desirable to implement an authentication mechanism to avoid the user's data being accessed by an unauthorised device. However, in practice it may not be desirable for the user device to supply all the data requested by the server, or to accept all the data supplied by the server. This may apply if the server is trusted in respect of some data but not trusted in respect of other data. The client device may store datasets that are mirrored on multiple servers, or within a single dataset some fields may be mirrored on one server and some on another server. For example, it may be undesirable to make work emails (that are mirrored on a work email server) to a web email server that mirrors a user's private emails. It would be desirable for the client device to be able to allow only a selected server to access each dataset or part-dataset. However, the protocols that are commonly used for synchronisation are open-ended and extensible so as to apply to a range of data types and do not provide a mechanism for this to be done.

In the case of synchronisation of user data, such as emails or contacts, (known as data synchronisation: DS) there is typically little if any authentication of a server in respect of that specific dataset. Typically, if a dataset on the user device (client) is available for synchronization then it can be accessed by any server that has been authenticated to the user device. In the case of transfer of configuration data (known as device management: DM) server authentication is typically more selective; in that a security certificate may be required to access certain types of data and in that access control lists (ACLs) can be used to control access to some resources on the user device. ACLs are lists indicating which datasets may be provided by the user device to a particular server. Each dataset is conventionally represented by a node in the ACL hierarchy. When a server attempts to access data on the user device but is denied access, the user device returns a message informing the server that it is denied access. However, even ACLs used in this way have the limitation that they cannot allow a user device to selectively provide some but not all of the information in a dataset to a server that is allowed to access at least some data of that dataset. This is a weakness of current protocols.

Another weakness of current protocols is that a server might be able to glean information about the data stored on the user device simply from the message that informs the server that it is denied access. Such a message may indicate that data of the type that the server tried to access is stored on the device. For example, a malicious server could try to access configuration data relating to an application that has a known vulnerability. If it receives an “access denied” message then the server could infer that the application is installed on the respective client device and begin an attack on that application.

As DS and DM technologies become more pervasive, and since they use published protocols, it is anticipated that DS and DM servers will be more widely deployed, allowing users to synchronise various types of data with user devices. The deployment of DS and DM servers by for personal, corporate or workgroup use or by parties who are less trusted than an ultimate manager of the user device has value to users, in that it provides convenient means of managing and backing up their data and aspects of their devices. However, as indicated above, there may be some personal data or some configuration data should not be shared with these “less trusted” servers.

There is therefore a need for an improved mechanism of filtering the data that is transferred between devices during synchronisation.

According to the present invention there is provided a data transfer client device comprising: memory for storing at least one dataset comprising a plurality of data fields and at least one filter definition comprising data defining which of the data fields can be accessed by a particular server; an interface for communicating with a data transfer server, whereby a data transfer server can access a dataset stored in the memory; and a data transfer controller for policing access during a data transfer operation by a data transfer server to the data fields, the data transfer controller being arranged to determine in dependence on the filter definition whether the data transfer server can access particular data fields and to deny the server access to those data fields to which the data transfer controller determines that the data transfer server cannot have access.

According to a second aspect of the present invention there is provided a a method for performing data transfer between a data transfer client device and a data transfer server, the method comprising: storing at least one dataset comprising a plurality of data fields and at least one filter definition comprising data defining which of the data fields can be accessed by a particular server; and during a data transfer operation, policing access by a data transfer controller of the data transfer client to the data fields, the policing comprising determining in dependence on the filter definition whether the data transfer server can access particular data fields and denying the server access to those data fields to which it is determined that it cannot have access.

The filter definition may comprise data defining at least one server and at least one filter criterion that can be applied to data fields. The data transfer controller may then be arranged to determine whether to deny that server access to a particular data field in dependence on whether that data field meets the criterion. The filter criterion may specify content of a data field. The data transfer controller may then be arranged to determine whether to deny the server defined by the filter definition access to a particular data field in dependence on whether the content of that data field matches the specified content.

The data fields may be comprised in data records. The filter definition may comprise data defining at least one server and at least one filter criterion that can be applied to data records. The data transfer controller may then be arranged to determine whether to deny servers access to a particular data field in dependence on whether the data record that comprises that data field meets the criterion. The filter criterion may specify content of a data field. The data transfer controller may then be arranged to determine whether to deny the server defined by the filter definition access to a particular data field in dependence on whether the content of another data field comprised in the same data record as the said particular data field matches the specified content.

There may be multiple filter definitions. Each filter definition may include multiple filter criteria. Each filter criterion may take the form of an expression specifying a template that can be tested against data content to determine whether it matches the content. Each filter criterion may include an indication of which data field(s) of a record the criterion should be applied to. The data transfer controller may be arranged to process such criteria, including such criteria that specify multiple forms of content by means of wildcards, regular expressions or the like.

The data transfer controller may be arranged to, on the initiation of a data transfer operation with a server, determine the identity of that server. It may subsequently perform the said determination of whether that data transfer server can access particular data fields of the data records in dependence on a stored filter definition that defines which of the data fields of the dataset can be accessed by that particular server, or if no such definition is available to the data transfer controller to deny that server access to the dataset.

The data transfer controller may be arranged to determine the identity of a server by means of an authentication routine performed with that server.

The data transfer controller may be arranged to, on denying a data transfer server access to one or more data fields, transmit no notification of that denial to the server. The data transfer controller may be arranged to, on denying a data transfer server access to one or more data fields, transmit to the server a message indicative of a failure to physically access such data fields.

The said access may include read access and/or write access.

The memory may store the said dataset. The memory may store the filter definition, or more than one filter definition. The memory may store two filter definitions, those filter definitions defining that some of the fields of a group of records of a dataset can be accessed by a first server and not by a second server and that others of the fields of the same group of records can be accessed by the second server and not by the first server. The memory may store two datasets and two filter definitions, those filter definitions defining that at least some of the fields of one of the datasets can be accessed by a first server and not by a second server and that at least some of the fields of the other of the datasets can be accessed by the second server and not by the first server.

The data transfer process may be a device management process. Such a process may be a process according to the Open Mobile Alliance standard or an equivalent thereto or may be according to another device management protocol. The data transfer process may be a data synchronisation process according to the Open Mobile Alliance standard or an equivalent thereto or may be according to another synchronisation protocol.

The dataset may be the data represented by a device management node. The data transfer controller or another access controller may implement a second access policy that, independently from the filter definition, defines which servers can access data at each node. That node-level policy is preferably subordinate to the filter definition.

The present invention will now be described with reference to the accompanying drawing. In the drawing:

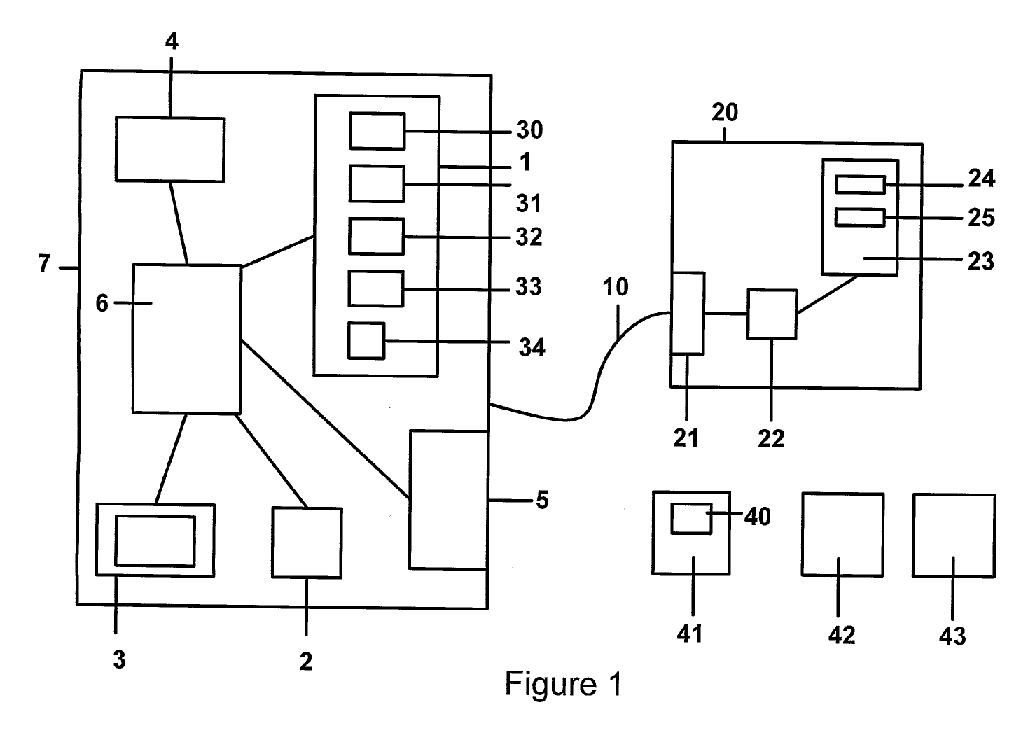

FIG. 1 is a schematic diagram showing a mobile phone synchronising with a server; and

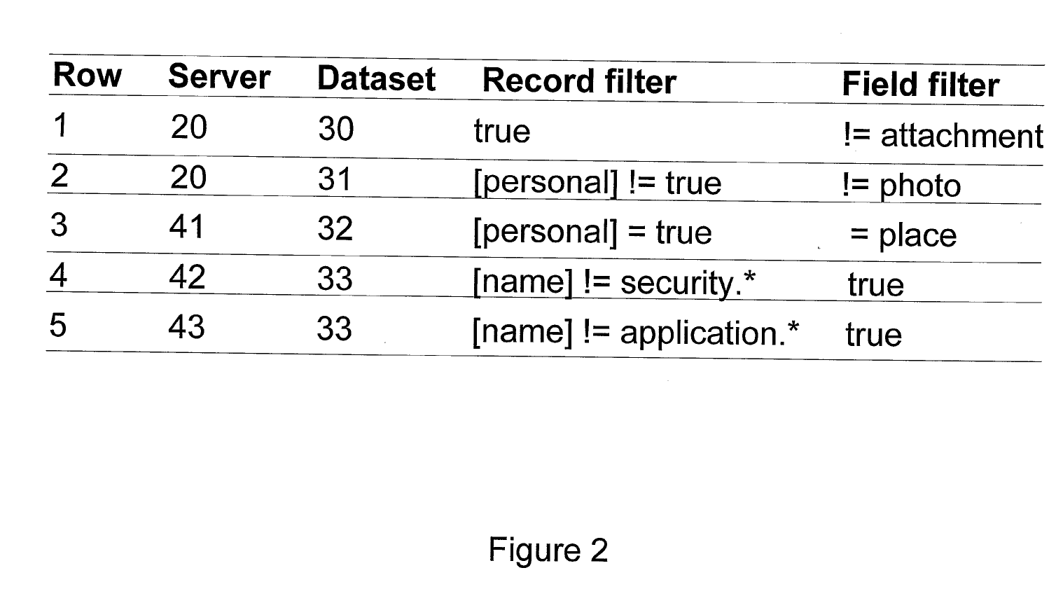

FIG. 2 illustrates a filtering table.

The mobile phone 7 of FIG. 1 has a non-volatile memory 1 that stores configuration settings for use during synchronisation. Those settings include a list 34 of data that defines what datasets or parts of datasets each server that authenticates with the mobile phone will be allowed to synchronise with. When a server synchronises with the mobile phone it authenticates itself to the phone. The phone then looks up the appropriate definition in the memory 1 and filters the data that it sends to or receives from the server in accordance with that filter.

The mobile phone 7 of FIG. 1 comprises a user input device 2 such as a keypad, a user output device 3 such as a display, a radio frequency (RF) transceiver 4 for communicating with a mobile phone network and a short-range interface device 5. A processor 6 is coupled to those components and to the memory 1. The short-range interface device could, for example, be a physical electrical connector and associated controller, a short-range radio transceiver using Bluetooth or wireless LAN (local area network) protocols or an infra-red transceiver. In the present example the short-range interface is a physical USB (universal serial bus) interface and the mobile phone is connected to a server 20 via a USB cable 10. The server could connect to the mobile phone via its RF transceiver 4.

The server comprises an interface 21 for communicating with the mobile phone, a processor 22 and a datastore 23.

In this example the server 20 is a corporate email server, which stores users' mailbox files on the datastore 23. Those include a dataset 24 of email data for the user of the mobile phone 1 and a dataset 25 of contact data for the user of the mobile phone 1. The email data includes a series of records, each corresponding to a respective email. Each of those records includes a set of fields including a “to” field, a “from” field, a “subject” field and a “content” field. The contact data includes a series of records, each corresponding to a respective contact. Each of those records includes a set of fields including “name”, “phone number” and “email address”. In practice email and contact data typically includes numerous other fields.

The mobile phone 1 stores a dataset 30 of email data which corresponds to the dataset 24, a dataset 31 of contacts data which corresponds to the dataset 25, a dataset 32 of appointments data which corresponds to a dataset 40 stored on another server 41 and a dataset 33 of configuration data which is managed by one or more device management servers 42, 43. The servers 41-43 operate in an analogous way to the server 20. More than one server could connect to the client at once if the client's interface(s) support that.

A dataset will typically be saved in a single file according to the file system of the device, although it could be spread over two or more physical files, for example with more frequently accessed records in one file and the remaining records in another file. The dataset may be formatted for access by a database interpretation program or component of an application that is to use the data in the dataset. The dataset may include a header or other meta-data that defines the format of the dataset, for instance which fields are included in the records. Other than meta-data, a dataset will typically consist of a set of like records. A dataset will typically be intended for interpretation by a single application, but it may be accessed by other applications.

The filtering table illustrated in FIG. 2 is stored in the memory 1 of the mobile phone 7, as shown at 34. It has a set of entries represented by rows in the table. Each entry has data identifying a server (in the table of FIG. 2 the servers are identified by the reference numbers used in FIG. 1) and for each server a list of one or more datasets, and for each of those datasets a filter definition indicating a set of records and fields. The format of the table could take any convenient form. For example, there could be a list of filter definitions for each server. In general it is preferred that the table comprises one or more entries, each of which defines at least one server and at least one test that can be applied to data. The device storing the data can then apply that entry by permitting or denying the or each server defined by the entry access to data in dependence on whether the data meets the test. It can do this by, in response to a request from a server to access certain data or a certain class of data, applying the or each test that is relevant to that server to the data in question and in dependence on that permitting or denying the server access to the data. Different filter definitions may apply to different types of access by a particular server. For example, one filter definition may apply to read access and another may apply to write access.

For many types of data such filter entries provide a more efficient method of defining whether a server should have access to data than do traditional access control lists. Traditional access control lists are defined using a tree-like hierarchy, with a definition at each node of the tree of which servers can access data at that node. In complex tree structures this calls for many definitions, which occupy a considerable amount of memory. In addition, ACLs of this type cannot flexibly define a subset of fields or data entries at a node to which a server should be permitted or denied access. For instance, if a node holds records of contacts and ACL that indicates at the node level which servers have access to those records cannot readily limit the server's to accessing only some of those contacts (e.g. only to work-related contacts) without those contacts being stored at a different node.

In the table illustrated in FIG. 2 terms enclosed in square brackets represent the values of fields, the character “!” represents NOT and the character “*” is a wildcard. By default a server cannot access a dataset on the device 7. A server can only access a dataset on the device if there is an entry in the table for that pairing of server and dataset, and then it can only access the entries that match both the record and field filters in that row of the table. Thus row 1 of the table indicates that server 20 can access only those records in dataset 30 where the term “true” is true (i.e. all records) and only those fields where the term “!=attachment” is true (i.e. all fields other than the attachment field). Row 2 of the table indicates that server 20 can access only those records in dataset 31 where the term “[personal]!=true” is true (i.e. all records where the value of the personal field is not set to true) and only those fields where the term “!=photo” is true (i.e. all fields other than the photo field). Row 4 of the table indicates that server 42 can access only those records in dataset 33 where the term “[name]!=security.” is true (i.e. all records where the name field does not begin “security.”) and only those fields where the term “true” is true (i.e. all fields).

The processor 6 of the mobile phone runs code that administers the access by servers to datasets that are held on the device. The code could be stored in non-volatile memory on the mobile phone. The processor authenticates a server that attempts to access a dataset by analysing identification information received from the server. If authentication is successful then when the server attempts to access data in a dataset on the phone, either for reading or for writing, the processor 6 uses the table 34 to verify that it is permitted to perform that access. If it is not then the processor ignores the access attempt. It may return a message to the server to indicate that access has been denied, but it is preferred that it does not do so, since returning such a message could provide the server with information about the data stored on the mobile phone.

An example of the data transfer process used during synchronisation will now be described.

The user connects the mobile phone 1 to server 20 via cable 10, providing a communication route between the two. Synchronisation is then initiated either automatically or manually.

The mobile phone and the server authenticate themselves to each other by any suitable authentication mechanism. They could simply exchange information indicating their identities, but more preferably they undertake a challenge-response protocol that gives a greater degree of protection against falsification of identity. Once the server has been authenticated the processor 6 knows which rows of the table 34 apply to that server, and hence can determine which data that server is allowed to access.

The server then attempts to read data from one or more datasets on the device. It does this by making a request to the device for data from the appropriate dataset. Some examples will be given:
Server 20 could request data from dataset 32. That request will be denied since there is no entry matching server 20 to dataset 32 in the table 34. No data will be returned to the server.
Server 20 could request data from dataset 30. Data from all the requested records in dataset 30 will be returned, but the attachment field will be omitted from each returned record.
Server 20 could request data from dataset 31. Data from all the requested records in which the personal field is not true will be returned, but the photo field will be omitted from each returned record.

Having read data, the server will in the normal way integrate that with its own dataset.

The server may also attempt to write data to one or more datasets on the device. It does so by transmitting to the device the data to be written and in indication of where in the dataset the data is to be written. The processor 6 will apply the same filtering to data to be written. If the data that is to be written does not match a filter definition at both a record and a field level then the data will not be written to the dataset. Some examples will be given:
Server 20 could request to write data to dataset 32. That request will be denied since there is no entry matching server 20 to dataset 32 in the table 34
Server 20 could request to write data to dataset 30. Data will be written to all the records in dataset 30 to which writing is requested, but any requests to write data to the attachment field will be denied. Data can, however, be written to the other fields of each record.
Server 20 could request to write data to dataset 31. Data can be written to any records in which the personal field is not true, but requests to write data to the photo field will be denied.

Requests to delete data are treated in an analogous way to requests to write data.

As indicated above, it is preferred that if requests (or parts of requests) for reading or writing are denied, they are simply ignored, with no indication of the denial being returned to the server. This has the effect of transparently hiding areas of data on the mobile device from servers that are not allowed access to that data. Meanwhile the same server may be allowed access to other data, and other servers may be allowed access to the data hidden from some servers. By hiding whole areas of data or by filtering out specific items of information, a less-trusted server is not informed that they exist. If a server requests a list of data the hidden areas will not appear in the returned data. Similarly, if the server attempts to write to areas or items that are hidden, the supplied data will be ignored or rejected. In this way, hidden areas are protected from manipulation.

Instead of the mobile phone returning no indication of a denial it could return another type of message that indicates a failure to physically access the requested data, for example “data not found” or “data access error”. Such messages avoid giving the impression that access has been denied on security grounds.

The table 34 could be configured manually by a user of the mobile phone or could be configured remotely, for example by a network operator. The user interface of the mobile phone could be arranged to allow for convenient configuration of the table, e.g. by allowing the user to select from a number of pre-defined policies. The table could itself represent a dataset and one or more rows in the table could control access by servers to the table, e.g. by DM. Instead of using a table or policy store such as table 34 the configuration of the hiding or filtering can be done on a case-by-case basis. The use of policies allows a more flexible and more efficient approach.

The protocol used between the mobile phone client 7 and a server may involve an exchange of field specifications before data is exchanged. If that is to happen then the processor 6 filters the field specifications that it informs the server about based on the appropriate row of the table 34. It only informs the server of those fields of the dataset with which it is permitted to exchange data. For example, if server 41 were synchronising with dataset 32 then in accordance with row 4 of table 34 the mobile phone would only inform the server of the place field.

The use of filtering as described above provides significant advantages over other synchronisation techniques. It allows improved control over the data that can be shared with or received from servers, allowing devices such as mobile phones to more securely accept data transfer with DS and DM servers from a range of sources and managed by a range of organisations or individuals. Today, DM servers (for example) are very powerful in that they have access to sensitive configuration information on a mobile device while DS servers have access to all of a user's person information management (PIM) data. The use of filtering as described above allows those access rights to be limited whilst still permitting useful synchronisation with such servers. Servers can have partial access to a dataset, and different parts of a single dataset can be synchronised with different servers.

The techniques described above are not limited to use with OMA protocols. Any standard or non-standard synchronisation protocols or other data transfer protocols such as data management protocols could be used for communication between the mobile phone and a server.

In conventional device management protocols (see, for example, “OMA Device Management Tree and Description, Candidate Version 1.2-24 Apr. 2006”, available from www.openmobilealliance.org), nodes are defined. Conventionally, each node represents a set of data. Access control is implemented by permitting or denying servers access to data at the node level. When the filtering techniques described above are used in connection with device management, they may be used to permit or deny access to individual data fields within a particular node. This is particularly useful when the client is configured simply to ignore requests from a server to access fields within a node to which that server does not have access rights. In that case, the client will appear to the server to be implementing a conventional node-level access system, maintaining compatibility with existing protocols, but the security of the client can be enhanced by restricting access. When the device polices node-level access in addition to policing field-level access a single piece of code or hardware could implement both levels of control. Alternatively, the controller function could be distributed between multiple pieces of hardware or software.

The processor 6 constitutes a controller for policing access by a synchronisation server to the datasets stored on the client device. The processor 6 is preferably implemented on a single integrated circuit but its functionality could be distributed over more than one integrated circuit or other device(s).

The client device need not be a mobile phone. It could be any suitable device. Non-limiting examples include notebook computers, PDAs (personal digital assistants) cameras and vehicle fault-logging systems. The server device could take any suitable form, for example a general purpose personal or industrial computer or a dedicated data transfer terminal. A synchronisation client or server could also be capable of fulfilling the opposite function. The connection between the client and the server could be wired or wireless, and could be direct or could run over one or more intervening networks.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A data transfer client device comprising:
memory for storing at least one dataset comprising a plurality of data fields and at least one filter definition comprising data defining which of the data fields can be accessed by a particular server;
an interface for communicating with a data transfer server, whereby a data transfer server can access a dataset stored in the memory; and
a data transfer controller for policing access during a data transfer operation by a data transfer server to the data fields, the data transfer controller being arranged to determine in dependence on the filter definition whether the data transfer server can access particular data fields and to deny the server access to those data fields to which the data transfer controller determines that the data transfer server cannot have access.

2. A data transfer client device as claimed in claim 1, wherein the filter definition comprises data defining at least one server and at least one filter criterion that can be applied to data fields, and the data transfer controller is arranged to determine whether to deny that server access to a particular data field in dependence on whether that data field meets the criterion.

3. A data transfer client device as claimed in claim 2, wherein the filter criterion specifies content of a data field and the data transfer controller is arranged to determine whether to deny the server defined by the filter definition access to a particular data field in dependence on whether the content of that data field matches the specified content.

4. A data transfer client device as claimed in claim 1, wherein the data fields are comprised in data records and the filter definition comprises data defining at least one server and at least one filter criterion that can be applied to data records, and the data transfer controller is arranged to determine whether to deny servers access to a particular data field in dependence on whether the data record that comprises that data field meets the criterion.

5. A data transfer client device as claimed in claim 4, wherein the filter criterion specifies content of a data field and the data transfer controller is arranged to determine whether to deny the server defined by the filter definition access to a particular data field in dependence on whether the content of another data field comprised in the same data record as the said particular data field matches the specified content.

6-37. (canceled)

38. A data transfer client device as claimed in claim 1, wherein the data transfer controller is arranged to, on the initiation of a data transfer operation with a server, determine the identity of that server and to subsequently perform the said determination of whether that data transfer server can access particular data fields in dependence on a stored filter definition that defines which of the data fields of the dataset can be accessed by that particular server, or if no such definition is available to the data transfer controller to deny that server access to the dataset.

39. A data transfer client device as claimed in claim 38, wherein the data transfer controller is arranged to determine the identity of a server by means of an authentication routine performed with that server.

40. A data transfer client device as claimed in claim 1, wherein the data transfer controller is arranged to, on denying a data transfer server access to one or more data fields, transmit no notification of that denial to the server.

41. A data transfer client device as claimed in claim 1, wherein the data transfer controller is arranged to, on denying a data transfer server access to one or more data fields, transmit to the server a message indicative of a failure to physically access such data fields.

42. A data transfer client device as claimed in claim 1, wherein the said access includes read access.

43. A data transfer client device as claimed in claim 1, wherein the said access includes write access.

44. A data transfer client device as claimed in claim 1, wherein the memory stores the said dataset.

45. A data transfer client device as claimed in claim 1, wherein the memory stores the filter definition.

46. A data transfer client device as claimed in claim 45, wherein the memory stores two filter definitions, those filter definitions defining that some of the fields of a group of records of a dataset can be accessed by a first server and not by a second server and that others of the fields of the same group of records can be accessed by the second server and not by the first server.

47. A data transfer client device as claimed in claim 45, wherein the memory stores two datasets and two filter definitions, those filter definitions defining that at least some of the fields of one of the datasets can be accessed by a first server and not by a second server and that at least some of the fields of the other of the datasets can be accessed by the second server and not by the first server.

48. A data transfer client device as claimed in preceding claim 1, wherein the data transfer process is a device management process according to the Open Mobile Alliance standard or an equivalent thereto.

49. A data transfer client device as claimed in claim 1, wherein the data transfer process is a data synchronisation process according to the Open Mobile Alliance standard or an equivalent thereto.

50. A data transfer client device as claimed in claim 1, wherein the dataset is the data represented by a device management node.

51. A method for performing data transfer between a data transfer client device and a data transfer server, the method comprising:
storing at least one dataset comprising a plurality of data fields and at least one filter definition comprising data defining which of the data fields can be accessed by a particular server; and
during a data transfer operation, policing access by a data transfer controller of the data transfer client to the data fields, the policing comprising determining in dependence on the filter definition whether the data transfer server can access particular data fields and denying the server access to those data fields to which it is determined that it cannot have access.

52. A method as claimed in claim 51, wherein the filter definition comprises data defining at least one server and at least one filter criterion that can be applied to data fields, and the method comprises determining whether to deny that server access to a particular data field in dependence on whether that data field meets the criterion.
